(19) United States
(12) Patent Application Publication
(10) Pub. No.: US 2009/0061399 A1
(43) Pub. Date: Mar. 5, 2009

(54) EDUCATIONAL SOFTWARE WITH EMBEDDED SHELTERED INSTRUCTION

(75) Inventors: Barbara FREEMAN, Carbondale, CO (US); John P. RAMO, Carbondale, CO (US); Michael A. WILLIS, Boulder, CO (US)

Correspondence Address: SUGHRUE MION, PLLC, 2100 PENNSYLVANIA AVENUE, N.W., SUITE 800, WASHINGTON, DC, 20037, US

(73) Assignee: DIGITAL DIRECTIONS INTERNATIONAL, INC., Carbondale, CO (US)

(21) Appl. No.: 11/848,118

(22) Filed: Aug. 30, 2007

(51) Int. Cl. G09B 19/08

(52) U.S. Cl. 434/157

(57) ABSTRACT

A system, method and a computer readable medium for providing virtual learning of academic topic unrelated to languages in a non-native language of a student. The system includes an input device, which receives user input, a datastore, which stores the academic topic. At least a portion of the academic topic is stored in both native and non-native languages. The system further includes a processor, which obtains the academic topic based on the user input and an output device, which outputs the academic topic provided by the processor to a user. The academic topic is obtained by the processor with sheltered instruction in the non-native language. Upon a user request, the continuous providing of the academic topic is paused and at least one key term of the academic topic is provided in the native language.

### BACKGROUND OF THE EXEMPLARY EMBODIMENTS OF THE INVENTION

1. Field of Exemplary Embodiment of the Invention

A method, a system, and an apparatus consistent with an exemplary embodiment of the present invention relates to a virtual learning system that educates non-native-language students in various academic topics unrelated to languages. More particularly, an exemplary embodiment of the present invention is consistent with providing a virtual learning system for learning and teaching academic topics unrelated to languages in a non-native language by embedding sheltered instruction into interactive multimedia content.

2. Description of the Related Art

The number of students in United States schools for whom English is a non-native language has increased dramatically in recent years. Such students must be educated in United States schools in academic subjects unrelated to languages (hereinafter “subject”) such as mathematics, science, business studies, etc. Schools by and large have been unsuccessful in this effort as evidenced in the high failure rate on academic subject standardized assessments by non-native-language students. Poor achievement manifests itself in high levels of student dropouts. The implications of which are significant, including economic and societal disadvantage and the inability to compete for jobs in a global labor market; making improving educational attainment for non-native language students, a societal imperative, especially in this accelerated “knowledge economy”. This issue—and the pedagogical challenges it presents—is particularly acute for students who are not academically literate in their native language and may not have inherited the economic means, cultural capital and/or social capital in the form of educational opportunities and material resources, which other students may have received.

Given the persistent academic underachievement of many non-native-language students, the intersection of language development and literacy acquisition—particularly literacy acquisition in subject areas is of particular significance. Language may be viewed as both a means and an end; a means to construct scientific meaning and participate in scientific inquiry and practices, and an end to communicate ideas and make informed decisions. A word is a portal through to a concept. To understand subject-content, a student needs to be able to read, problem solve and communicate using technical language in a specialized context. For example, the language of science can be as challenging as a foreign language. One obvious reason for this is that many science terms are brand new to learners (e.g., plasma, stratosphere, torque). Another reason is that many science terms are deceptively familiar (e.g., pressure, work, energy), with the scientific definitions of these terms being much more specific and complex than their everyday definitions. This can lead to students thinking they understand these terms and the concepts they represent long before they really do—which, in turn, can lead to misconceptions that students must overcome before they are able to master the concepts. Although it is said that mathematics is a universal language, learning the subject presents similar challenges. It is also a technical language (e.g., coefficient, hypotenuse, tessellation) with deceptively familiar terms (e.g., value, scale, product) that can be very difficult for students to master, and can significantly impede their progress in, and enjoyment of, their mathematical studies.

If a student cannot understand what is being said in a subject classroom, then it is difficult to move beyond the language to master the subject content and skills—no matter how gifted the student may actually be in the given subject.

One way to help non-native-language students succeed academically is to recognize the need to develop the student's technical language of the subject, as well as simultaneously developing their cognitive academic language proficiency—the kind of proficiency required to make sense of language in a non-social environment.

An appreciation for the distinction between social language (basic interpersonal communications) and cognitive academic language is needed to understand why a special approach toward the learning of subject matter for non-native-language students is a necessity. Language is used in many different context-specific environments outside of the social environment, e.g. the school, workplace, court, the army, etc. One particular contextual example of this is academic language—such as academic English—which is defined as “the ability to read, write, and engage in substantive conversations about math, science, history, and other school subjects” (American Educational Research Association, 2004, p. 2). Academic language relies on a wide understanding of words, concepts, language structures, and interpretation strategies. It includes vocabulary used beyond social conversations and includes vocabulary required to communicate effectively, and comprehend materials, in academic content area classes.

Academic language is the language of the classroom, of text, tests, standardized assessments, and college and job interviews; many people confuse academic language with “content” language, that is, language particular to a field of academic content. Content language (hypotenuse, scale) is just a part of academic language. Academic language can be single words, phrases (groups of words without a conjugated verb: “which of the following”), or grammatical constructions such as cause and effect language: if . . . then, or if . . . always . . . then . . . always . . . ) or whole clauses (groups of words that include conjugated verbs).

One effective classroom-based instructional methodology for teaching subject content to non-native-learners is the use of sheltered instruction, or sheltered subject matter teaching. Sheltered or scaffolded teaching strategies and methods in support of a student's development have their roots in the zone of proximal development. “The zone of proximal development is the distance between what children can do by themselves and the next learning that they can be helped to achieve with competent assistance” (Van Der Stuyf, R. (2002). Scaffolding as a Teaching Strategy. Nov. 17, 2002; Vygotsky, L. S. (1978). Mind in society. Cambridge, Mass.: Harvard University Press, p. 140). The scaffold or support enables the student to metaphorically step or reach to the next level, just beyond that which they would have been able to achieve on their own.

The Center for Research on Education, Diversity & Excellence created a research-based measurement tool called Sheltered Instruction Observation Protocol (SIOP) designed to measure the quality of classroom-instruction delivered using sheltered instruction strategies (Short & Echevarria, 1999). SIOP is a model that helps teachers incorporate sheltered instruction principles and strategies into their lessons and to effectively deliver sheltered lessons to non-native-language students in their classroom. For example, instead of just explaining a concept, the teacher may provide a visual illustration of the concept.

SIOP, however, is a classroom-based, teacher-implemented model. This SIOP model varies depending on the teacher and the classroom (e.g., the visual illustration will vary depending on the subject and the teacher). That is, there is no uniform SIOP model, as each model is teacher implemented. Each teacher does not have the resources to create the most effective lesson for each subject e.g., each teacher can only do so many visual illustrations and examples. Using teacher implemented SIOP, the lessons are consistently not as effective as they could be. Furthermore, the classroom instructions do not account for the individual needs of the students e.g., some students may need five different examples whereas others may just need one example. If the classroom instructions provide two examples, some students will be bored and some will not grasp the concept. In short, the SIOP model suffers many deficiencies such as lack of uniformity for same subject and lack of flexibility for individual students.

Another project, which addresses the difficulties of learning subject matter for non-native-language learners is known (Engler et al., “The Impact of eLTR-Technologies on Mathematical Education of Non-Native Speakers,” TU Berlin Institute, Germany, year unknown). This project is designed for non-native students in the university's engineering school and focuses on a different linguistic-cultural challenge faced by these students: the barriers that may arise from different culture-specific aspects of mathematical language. For example, the Members Project recognizes the important influence that language has on how students perceive and think about abstract mathematical concepts and objects. Thus different grammatical/linguistic structures mean that non-native students may visualize mathematical concepts differently and have a different orientation and approach to problem-solving; one that is not necessarily wrong, just different from the orientation and/or solution of the native country teachers and assessors. The Project employs multimedia technologies and interactive components to aid non-native-language learners in applying mathematical concepts whilst learning and training in a different culture/country. This project uses multimedia but does not build on background knowledge, develop academic vocabulary, and embed sheltered instruction methods and principles in its content.

There are a few prior art examples of virtual learning systems that use multi-modal and multi-sensory methods for language acquisition and vocabulary development. The objectives and focus of these programs is on language (e.g. grammatical, semantic, vocabulary recall, etc.) as opposed to a subject (e.g. mathematics, science, business studies, etc.).

For example, in U.S. Pat. No. 7,052,278 B2 to Johnson et al., a virtual learning system with instruction in the non-native language is employed to train non-native-language learners to automatically recognize small components (e.g. sounds, words) that lead to larger grammatical structures (e.g. phrases, sentences), emphasizing the objective of functional language acquisition for effective listening and speaking and subsequently for reading and writing skills. It does not embed sheltered instruction techniques into the learning of a subject nor does it provide a method to consistently implement the dual objective of academic subject-concept development and non-native language development. This patent focuses on learning the language and not on studying a subject i.e., academic topics unrelated to languages.

U.S. Pat. No. 5,885,083 to Ferrell uses a multi-modal presentation of non-native vocabulary which focuses on sensory integration and speech recognition in order to train the individual in immediate word recognition and response. Whilst this system promotes the rapid development of vocabulary in a context-sensitive, non-social environment, the system focuses on developing the language and not subject-content development. It neither aims to build background knowledge nor does it employ sheltered instruction to develop a subject concept.

As is visible from above, conventionally, there is no method or system that would provide non-native language students a uniform studying model for academic topics unrelated to languages (subjects) that is flexible to fit student's individual needs and yet implements sheltered instruction and builds on background knowledge and the like so that non-native language students can effectively learn the subjects in the non-native language. A unified and integrated method and system, which embed sheltered instruction into interactive multimedia content and provide learning of the subject with the learning of the non-native language including the requisite technical language of the subject and the contextual, specialized language of the academic topic, are needed.

### SUMMARY OF THE EXEMPLARY EMBODIMENTS OF THE INVENTION

One aspect of the present invention is to provide a method, a system, and instructions stored on a computer readable medium that provide an improved virtual learning of an academic subject in non-native language to the student. Another aspect of the present invention is to provide virtual learning which uniformly utilizes sheltered instruction. Yet, another aspect of the present invention is to provide the student with more flexibility in studying the academic subject in the non-native language.

Illustrative, non-limiting embodiments of the present invention may overcome the above disadvantages and other disadvantages not described above. The present invention is not necessarily required to overcome the disadvantages described above, and the illustrative, non-limiting embodiments of the present invention may not overcome some of the problems described above. The appended claims should be consulted to ascertain the true scope of the invention.

Accordingly to an exemplary, non-limiting formulation of the present invention, an internet-based virtual learning system is provided. The internet-based virtual learning system includes an input device, which receives user input, a datastore, which stores academic content, where at least a portion of the academic content is stored in native and non-native languages, a processor, which obtains said academic content based on the user input, and an output device, which outputs the academic content provided by the processor to a user. In this system, the academic content is obtained by the processor with sheltered instruction in the non-native language, and upon a user request, the providing of the academic content is paused and at least one key term of the academic content is provided in the native language.

According to another exemplary, non-limiting formulation of the present invention, a computer readable medium storing instructions for virtual learning of academic content in a non-native language is provided. The instructions include instruction for receiving user input, instructions for storing academic content, where at least a portion of the academic content is stored in native and non-native languages, instructions for obtaining said academic content based on the received user input, and instructions for outputting the academic content to a user. The academic content stored on the computer readable medium is obtained with sheltered instruction in the non-native language, and upon a user request, the providing of the academic content is paused and at least one key term of the academic content is provided in the native language.

According to yet another exemplary, non-limiting formulation of the present invention, a computer implemented method for virtual learning of academic content in a non-native language is provided. The method includes receiving user input, storing academic content, where at least a portion of the academic content is stored in native and non-native languages. The method further includes obtaining the stored academic content based on the received user input and outputting the obtained academic content. In this method, the academic content is obtained with sheltered instruction in the non-native language and upon a user request, the outputting of the academic content is paused and at least one key term of the academic content is provided in the native language.

According to another exemplary, non-limiting formulation of the present invention, a graphical user interface is provided on a computer. The graphical user interface includes a first view, which provides at least one key concept of an academic content in a non-native language of a user. Terms displayed in the first view for which definitions in a native language are available are marked in the first view. The graphic user interface also includes a tool bar, which provides menu options comprising a first option including a video stream introduction of at least one key concept in a non native language, a second option including an interactive game demonstrating the at least one key concept in the non native language, and a third option including a test of the at least one key concept in the non native language. The graphic user interface further includes a second view, which replaces the first view and displays the definitions in the native language when a user selects a term marked in the first view, and returns to the first view upon further user input.

### BRIEF DESCRIPTION OF THE DRAWINGS

The drawing figures depict, in highly simplified schematic form, exemplary, non-limiting embodiments reflecting the principles of the invention. Many items and details that will be readily understood by one familiar with this field have been omitted so as to avoid obscuring the invention. Same numeric references in various different figures denote analogous elements. The above and other aspects of the present invention will become more apparent by describing in detail exemplary, non-limiting embodiments thereof with reference to the attached drawings, in which:

FIG. 1 is a schematic representation of hardware of a virtual learning environment system according to an exemplary embodiment of the present invention.

FIG. 2 is a schematic representation of elements of a virtual learning environment system according to an exemplary embodiment of the present invention.

FIG. 3 is a schematic representation of components of an exemplary learning module of a virtual learning environment system according to an exemplary embodiment of the present invention.

FIG. 4 is a flow chart illustrating a method of providing a virtual lesson to a student using multimedia according to an exemplary embodiment of the present invention.

FIG. 5 is a flow chart illustrating a method of a student navigating within a lesson that contains multiple related subject-concepts or a single subject-concept according to an exemplary embodiment of the present invention.

FIG. 6 is a graphical user interface of a main menu for providing a virtual lesson using multimedia and sheltered instruction according to an exemplary embodiment of the present invention.

FIG. 7 is a graphical user interface of an activity in a virtual lesson using multimedia and sheltered instruction according to an exemplary embodiment of the present invention.

FIG. 8 is a graphical user interface of a vocabulary section in a virtual lesson using multimedia and sheltered instruction according to an exemplary embodiment of the present invention.

FIGS. 9A and 9B are graphical user interfaces of instruction section in a virtual lesson using multimedia and sheltered instruction according to an exemplary embodiment of the present invention.

FIG. 10 is a graphical user interface of practice questions section in a virtual lesson using multimedia and sheltered instruction according to an exemplary embodiment of the present invention.

FIG. 11 is a graphical user interface of game and scenario section in a virtual lesson using multimedia and sheltered instruction according to an exemplary embodiment of the present invention.

FIG. 12 is a graphical user interface of test taking skill section in a virtual lesson using multimedia and sheltered instruction according to an exemplary embodiment of the present invention.

FIG. 13 is a graphical user interface of testing section in a virtual lesson using multimedia and sheltered instruction according to an exemplary embodiment of the present invention.

FIG. 14 is a graphical user interface of native language support in a virtual lesson using multimedia and sheltered instruction according to an exemplary embodiment of the present invention.

FIGS. 15A and 15B are flow charts illustrating various methods of providing native language support in a virtual lesson to a student using multimedia according to an exemplary embodiment of the present invention.

FIG. 16 is a graphical user interface of interactive support in a virtual lesson using multimedia and sheltered instruction according to an exemplary embodiment of the present invention.

### DETAILED DESCRIPTION OF EXEMPLARY EMBODIMENTS OF THE INVENTION

Certain exemplary embodiments of the present invention will now be described more fully with reference to the accompanying drawings.

An exemplary embodiment of the present invention provides a unified and integrated method, system, and apparatus which embed sheltered instruction directly into the interactive multimedia content. This exemplary virtual system, method and apparatus have a dual, intertwined objective of integrating the learning of the subject with the learning of the non-native language including the requisite technical language of the subject and the contextual, specialized language of the academic and other non-social environments.

More particularly; an exemplary embodiment of the present invention captures three key pedagogical principles:

Principle 1: developing academic and other non-social language;

Principle 2: building academic background concept knowledge; and

Principle 3: making subject matter comprehensible without simplification of the concept.

The pedagogical principles of an exemplary virtual learning system are provided via sheltered instruction strategies and methods. These exemplary strategies and methods, which are discussed in greater detail below, include:
Method 1: breaking down subject concepts (e.g., concepts of math) into small comprehensible learning chunks;
Method 2: emphasizing subject-content and academic vocabulary;
Method 3: providing visual and contextual hints which may clarify the concept by explaining requisite background knowledge and recycling prior knowledge;
Method 4: modeling activities and providing interactive demonstrations and activities;
Method 5: presenting academic language and subject-concepts in multiple contexts, as well as repeating and revisiting key vocabulary as required;
Method 6: increasing connections to student's lives; and
Method 7: reviewing and assessing throughout the lesson i.e., as the language and concept are being developed, not just at the end of the lesson.

These exemplary pedagogical principles and instructional methods are embedded in an exemplary embodiment of the virtual learning system and apparatus at two levels: single subject-concept and multiple-related-concepts.

In an exemplary embodiment of the present invention, the virtual learning system is presented as a software program embodied on a computer readable medium that contains a series of subject lessons (e.g., Geometry, Earth & Space Science, Colorado History, etc.) in which non-native-language students learn multiple-related subject-concepts within each lesson whilst simultaneously developing their non-native language (e.g. English) abilities. In an exemplary embodiment, a learner may choose to work through all of the related and reinforcing concepts within the given subject lesson; or instead choose to navigate a particular path and focus on only one single concept.

In another exemplary embodiment, only one self-contained subject concept is presented. It is possible that the sheltered instruction subject-concept is delivered to the learner through a program stored on a disk that contains a series of subject lessons. It is also possible that the sheltered instruction subject-concept is delivered via a “learning-link” (i.e., sheltered instructional learning-sequence) presented as a single subject-concept (still embodying the dual objective discussed above). The learning-link could be delivered from third party software, search engine, embedded hyperlink, or some other form, such as an online thesaurus or dictionary. Further the learning-link could be made available for just-in-time learning to be pulled up on demand. For example, it could possibly sit as a desktop icon, or within a search icon or embedded into an application such as Word, or available as a link within any online information (e.g. Wikipedia, etc).

In another exemplary embodiment the retrieval of the single concept or multiple-related concepts could occur with the mediated assistance of a “virtual” teacher, tutor, mentor or companion, which would help the learner navigate through the subject-content and personalize and individualize that content to meet the individual learner's needs, abilities, learning style and so forth.

In still another exemplary embodiment, which may be designed with the intent of teaching the native speaker (e.g. English) subject-content (e.g. business studies, meat processing) in a non-native language (e.g. Russian), the main language of subject-content presentation could be the non-native language and the language support could be in the native language. In this exemplary embodiment, multimedia synchronicity (e.g. between video, text, and audio) would occur in the non-native language.

One of ordinary skill in the art would readily recognize that the virtual learning system, apparatus and method according to exemplary embodiments of the present invention can be used by non-native-language students to learn any subject in a non-social environment (e.g. law, mechanics of meat packing, computer applications, etc.).

In accordance with some of exemplary embodiments of the present invention, at both the single concept and multiple related concepts level, the virtual learning system delivers the three exemplary pedagogical principles and (at least) the seven exemplary sheltered instruction strategies and methods by implementing at least the following exemplary aspects:
Aspect 1: presenting interactive subject-content using multimedia and providing constructive feedback loops, as described in greater detail below;
Aspect 2: using the non-native language as the primary language of instruction, supported with native language instruction and translations, as described in greater detail below; and
Aspect 3: providing other interactive support tools, as described in greater detail below.
   Each of these exemplary aspects is described in greater detail below.

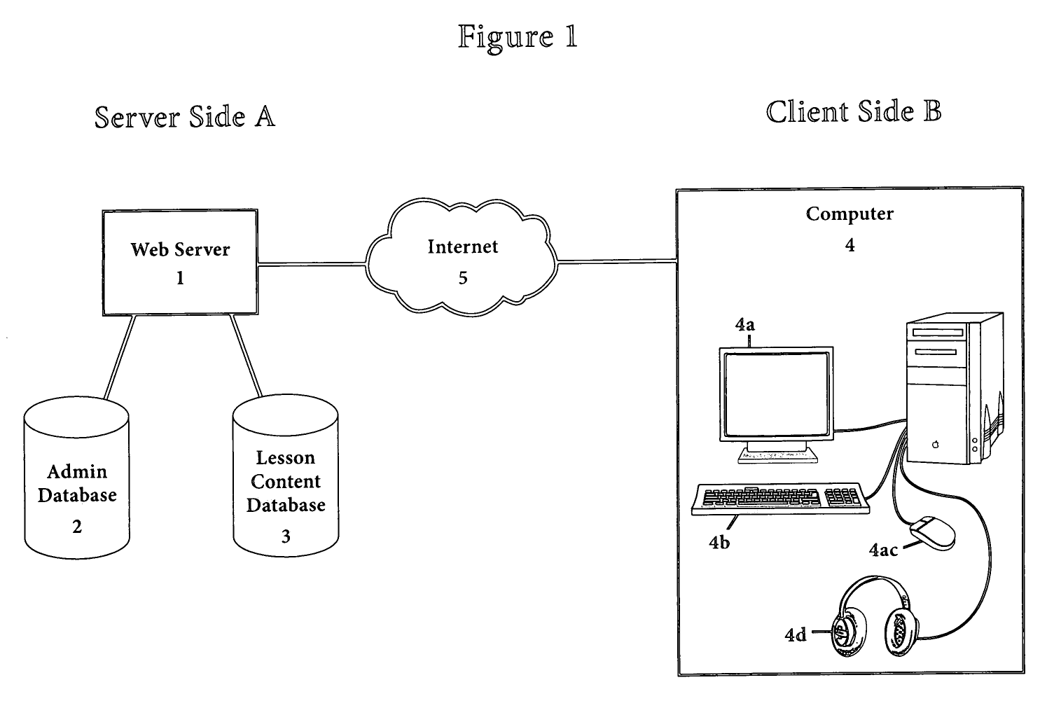

In an exemplary embodiment of the present invention, the virtual learning environment system includes a number of elements that are components of either the Server Side A or the Client Side B. As depicted in FIG. 1, the Server Side A includes a Web Server computer 1, which is communicatively connected to two databases. The Administrative (Admin) Database 2 stores data relative to testing and tracking a student's progress through the courses. The Lesson Content database 3 contains all the components that deliver the sheltered instruction, including audio, text, calculator, key terms, etc. The Client Side B includes a computer 4 such as a personal computer (PC). The computer includes a display 4a such as an LCD or any other known display, and various input/output devices such as a keyboard 4b, a mouse 4c, and a pair of speakers or headphones 4d to support audio in non-native and native languages. The Server Side A and the Client Side B are communicatively connected via the Internet 5, in a manner known in the art or in any other manner which may be developed in the future.

The lesson content may be delivered to the client computer 4 via a web browser that runs on the client computer 4, and a browser plugin such as Micromedia Flash. The components that deliver the sheltered instruction (for example in a Flash format) including audio, text, calculator, glossary terms, cartoons, etc, are presented to the student through the browser plugin. The student makes a request to the Web Server 1, via the browser, to display a specific subject concept or lesson on a display 4a. The Web Server 1 then retrieves the appropriate subject concept or lesson content from its database 3, and delivers it to the computer 4 over the Internet connection 10, to the browser. The browser then displays the lesson content on the display monitor via the browser plugin.

In another exemplary embodiment, virtual learning system with sheltered instruction may be delivered to a client computer on a computer readable medium such as a CD or DVD, which is inserted into the computer 4 or via a local network. Furthermore, the computer 4 may be a PC, a network terminal, a television set, a mobile phone, a personal digital assistant (PDA) device, and so on.

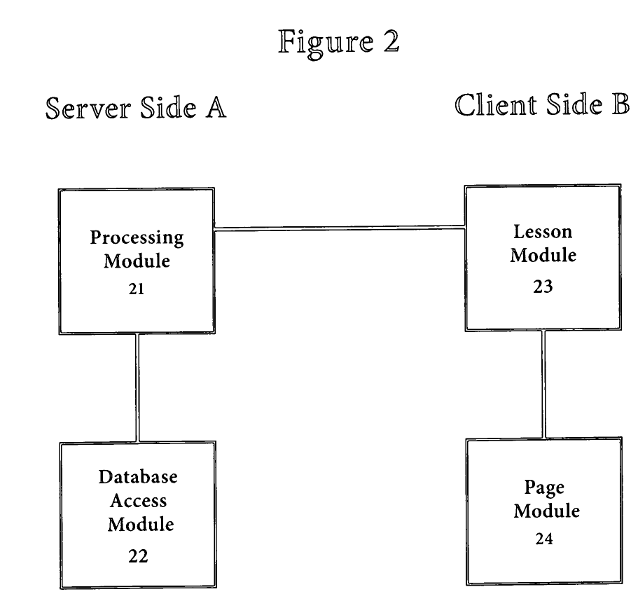

Turning to FIG. 2, it shows a schematic representation of elements of a virtual learning environment system according to an exemplary embodiment of the present invention. As depicted in FIG. 2, the server side A has a processing module 21 that resides on and is executed by a web server. The processing module 21 may include a communication sub module and may employ .Net to deliver web pages to the client side B. The processing module 21 may further include another communication sub module to communicate with a Database Access Module 22, such as an SQL Server, which manages the databases. The Database Access Module 22 searches for particular content in the databases, provides various contents to the processing module 21 and updates the data in the databases.

As explained above, the processing module 21 communicates with the client side B i.e., the web server running the processing module 21 communicates with a web browser that is running a lesson module 23. The processing module 21 sends data, in the form of text, graphics, and audio to the web browser, which is displayed on the student's computer screen. The web browser sends data back to the web server, which represents student input. In particular, when the student requests that a specific lesson be started, the web browser launches and executes the lesson module 23. A lesson may include multiple pages. The precise number of pages depends on the number and complexity of the single subject concepts. Each page teaches a specific component of the lesson. The page module 24 is used to run a specific page.

The page module 24 displays several multimedia elements that teach the topic of the page to the student. Some types of multimedia elements that may be employed by the page module 24 are: images of items such as a protractor and text including linked key terms (discussed in greater detail below). When a linked key term is clicked, a definition of the key term is displayed by the lesson module 23. The page module 24 communicates with the lesson module 23 to perform this task; Audio, which is synchronized with what is being displayed on the screen visually and audibly. The page module 24 may further allow for user interactions such as games, drag-and-drop, and multiple choice questions, which help better engage the student with the lesson and provide help information to the user when requested.

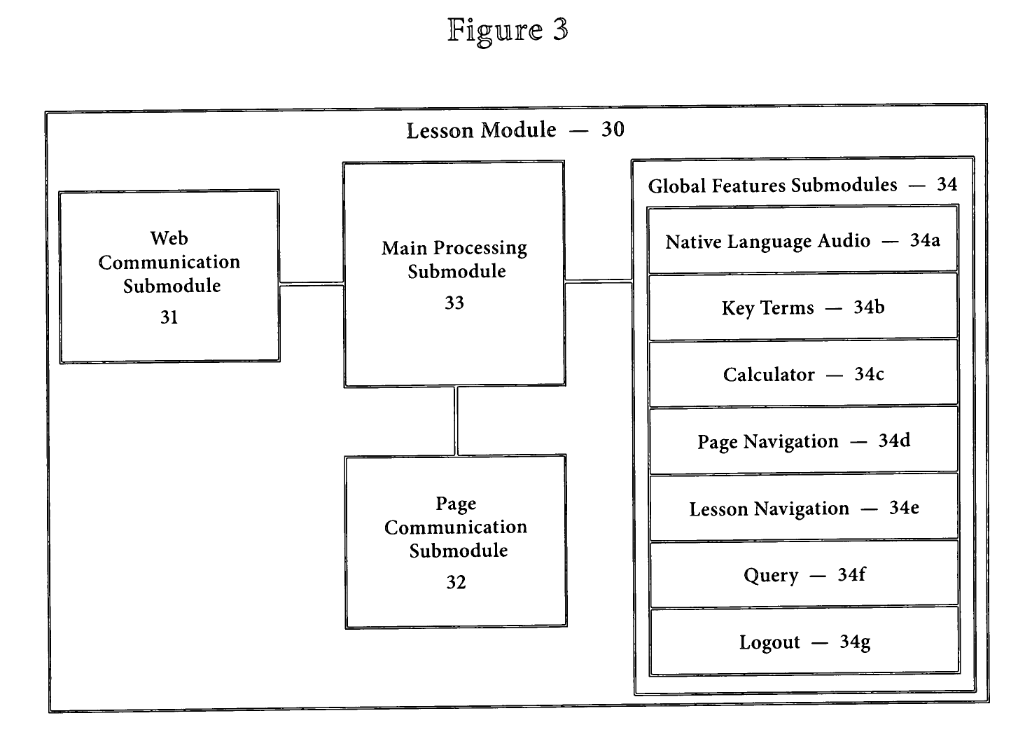

The lesson module 23 has sub-modules to execute the following operations:
(1) to launch the page module 24 to run the pages of the lesson. The pages can be run in sequence, or the student can specify which page to run next.
(2) to launch the page module 24 to run the pages that comprise a single concept. For example, the lesson module 23 could launch a series of pages to teach only the concept of corresponding angles.
(3) to provide a set of exemplary global features that support all lesson pages. These global features are executed by various sub modules of the lesson module, as shown in FIG. 3.
(4) to receive and interpret data from the processing module 21 of the server side A.

FIG. 3 shows exemplary component of the exemplary learning module 30 such as the one depicted in FIG. 2. The exemplary learning module 30 includes a web communication sub-module 31, which receives data from the web server and sends data received for example from the user to the web server. Another sub-module is page communication sub-module 32, which communicates with the page module for launching various pages.

A main processing sub-module 33 manages various other sub-modules of the learning module 30. This exemplary sub-module 33 may be executed by a central processing unit (CPU) of the user computer. The sub-module 33 processes information from the web server received via the web communication sub-module 31, processes information from the page module received via page communication sub-module 32, and processes user input. For example, the main processing sub-module 33 communicates with various global feature sub-modules 34 to execute various global features available for various different lessons. For example, the lesson module 30 displays a button on most pages of the lesson that would permit the user to launch these exemplary global features.

The global features sub-modules 34 include a native language audio 34a. If the student clicks on a button corresponding to this sub-module 34a, a narrative in the native language is played that describes certain aspects of a displayed page. The global features sub-modules 34 further includes a key terms sub-module 34b. If the student clicks on a button corresponding to this sub-module 34b, a definition is provided of the key terms offered by the system at the student's grade level. The global features sub-modules 34 further includes a calculator sub-module 34c. If the student clicks on a button corresponding to this sub-module 34c, a calculator is displayed for the student to use.

The global features sub-modules 34 further includes a page navigation sub-module 34d. This exemplary sub-module 34d provides buttons on a display of most pages of the lesson to allow fast-forward, rewind, pause, back, forward, etc movements within the lesson. In other words, this exemplary sub-module 34d allows the user to manipulate the running of the current page, or go to the next or previous page. The global-features sub-modules 34 further include a lesson navigation sub-module 34e. This exemplary sub-module 34e provides a lesson map so that the student can directly go to other pages within the lesson. There may also be a set of icons, which when clicked, instructs the main processing sub-module 33 via the sub-module 34e to run a different page that is closely related to the currently displayed page.

Another exemplary global feature sub-module is query sub-module 34f. This sub-module 34f is provided so that the student can communicate with an expert concerning the topics which are currently being displayed on the screen. The form of communication between the student and expert can currently be either via a text chat with the student and expert, email to the expert, a fax to the expert, or teleconferencing or video conferencing with the expert. In either case, the specific page that the student is viewing is sent to the expert, so that the expert can quickly view the page that the student was viewing at the time the student clicked a query button which launched the query sub-module 34f. Furthermore a logout sub-module 34g is provided. The logout sub-module 34g allows the student to quit the current lesson by shutting down the lesson module 30.

Other embodiments can employ different architectures to deliver sheltered instruction in the virtual learning system and are within the scope of the invention. For example, sheltered instruction may be delivered via a PC or some other device executing a CD or DVD. In this exemplary embodiment, the system would employ a web browser, a lesson module, and a page module but the server side A components would not be required if testing and tracking of the students is not desired.

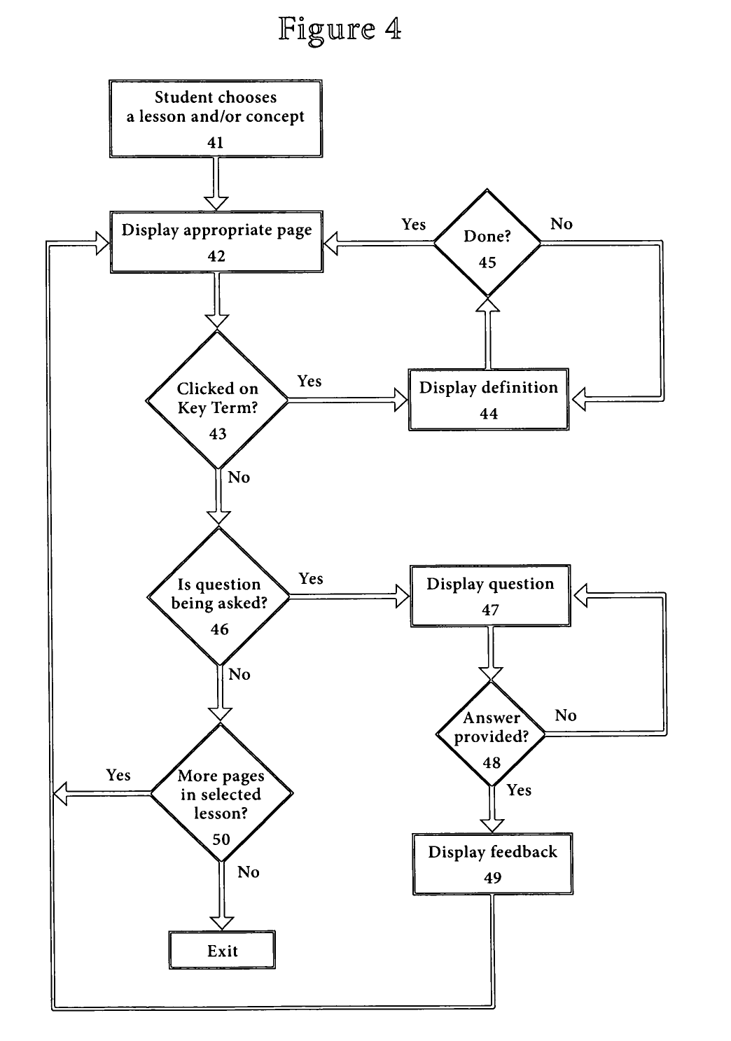

FIG. 4 is a flow chart illustrating a method of providing a virtual lesson to a student using multimedia according to an exemplary embodiment of the present invention. FIG. 4 provides an example of how the virtual learning system presents the interactive subject-content using multimedia and provides constructive feedback loops as noted in an exemplary first aspect; and also, how the student interacts with the virtual learning system.

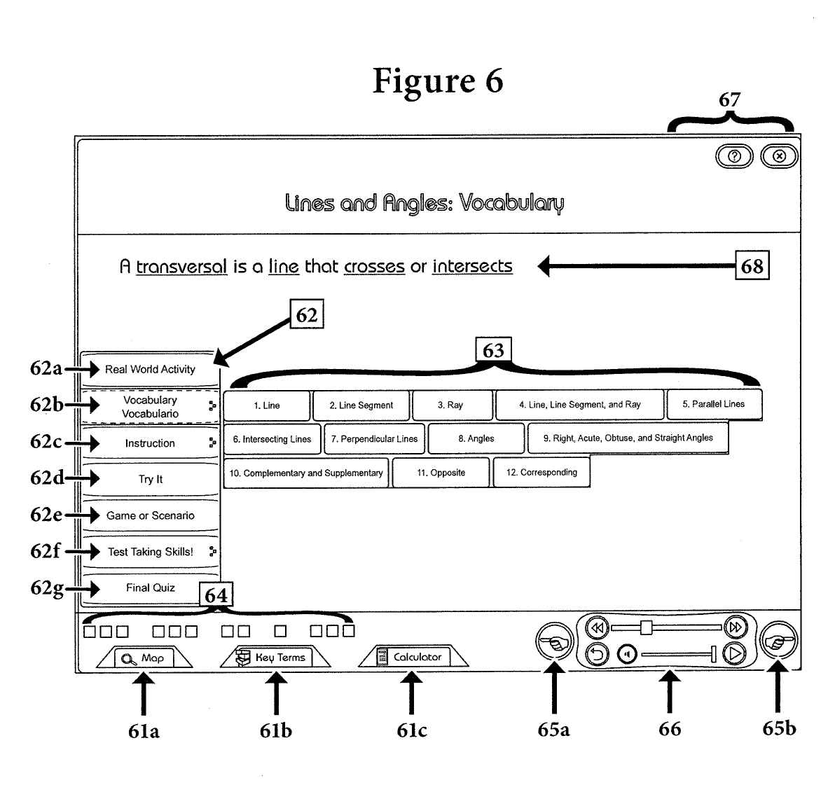

The lesson module displays elements that allow the student to choose a specific lesson and/or to choose a specific concept within a lesson, in operation 41 of FIG. 4. Once the student makes their choice, the lesson module launches the page module to deliver the specified lesson or concept. That is, the page module displays the appropriate page in operation 42. Each of the sheltered instructional methods are employed and embedded within each single subject-concept “learning-link” (i.e., sheltered instructional learning-sequence). Thus within each lesson, there are multiple subject-concepts, with multiple pages. Sheltered instruction methods are also embedded at the level of the individual page. The page module may employ several multimedia techniques to teach the specified lesson or concept. These techniques include, but are not limited to, video, graphics, synchronized audio, audio, cartoons, interactive manipulatives. The multimedia techniques are displayed in FIG. 6-FIG. 12 and described in more detail in the text that accompanies these figures.

In FIG. 4, the page module may send requests to the lesson module to perform some type of action, such as displaying a key term. This action is usually performed in response to the student clicking a linked key term that is being displayed in operation 43. When the student clicks on the linked key term, a new page providing a definition of the term in a native language is provided in operation 44. When the student is done reviewing the definition by clicking exit, for example, in operation 45 and the student is returned to the displayed page in operation 42. Until the student clicks exit in operation 45, the student will remain in the display of the definition.

From time to time, and throughout the learning sequence, the page module may ask the student a question in operation 46. The page module would then display the question, along with a list of possible answers in operation 47. When the student chooses an answer in operation 48, the page module displays feedback appropriate to the answer that the student chose in operation 49 and returns to operation 42 in which the appropriate page or next appropriate page is displayed. While an answer is not chosen in operation 48, the page module continues to display the question with possible answers. Next the learning module checks if more pages are available for the display of the selected lesson and concept in operation 50. If more pages are available, the method returns to operation 42 and the next appropriate page is displayed. If no more pages are available for the selected lesson and concept in operation 50, the method is completed and the system is returned to a main page in which the user can choose a lesson and a concept.

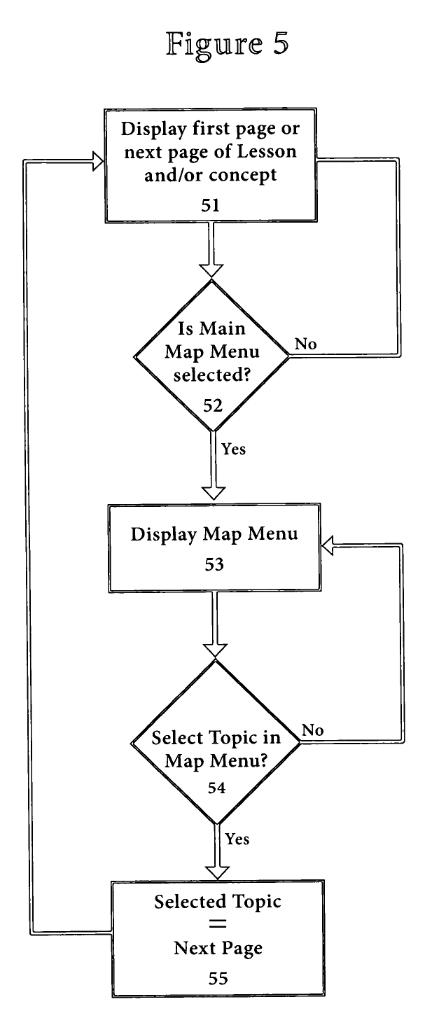

A student or user may freely navigate within a lesson that contains multiple related subject-concepts or within a single subject-concept as explained with reference to FIG. 5. This navigation is accomplished via cooperation between the lesson module and the page module. For example, a lesson and/or single concept is comprised of a series of pages. The lesson module controls the execution of the entire lesson or single concept, and the page module controls the execution of a single page.

In FIG. 5, when the lesson module is launched, it initially launches the first page of the lesson or single concept and displays at all times mapping elements, which the student can use to navigate within the lesson or single concept in operation 51. The lesson or concept is continuously presented to a user as a slide show or a movie with pauses for user input until the user selects a main map menu in operation 52.

If the student clicks the main mapping element in operation 52 at any time during the lesson, the lesson module displays a map menu in operation 53, which lists the topics in the lesson or single concept. If the student clicks one of the topics in the map menu in operation 54, the lesson module terminates the existing page and launches a new page in operation 55, to run the first page of the topic that the student selected in operation 51. In other words, the next page displayed, will be the first page of the selected topic. On the other hand, the map menu will be displayed until the student selects the topic or exits the map menu.

Next an exemplary embodiment illustrating learning of lines and angles will be described with reference to FIGS. 6 to 14 and 16.

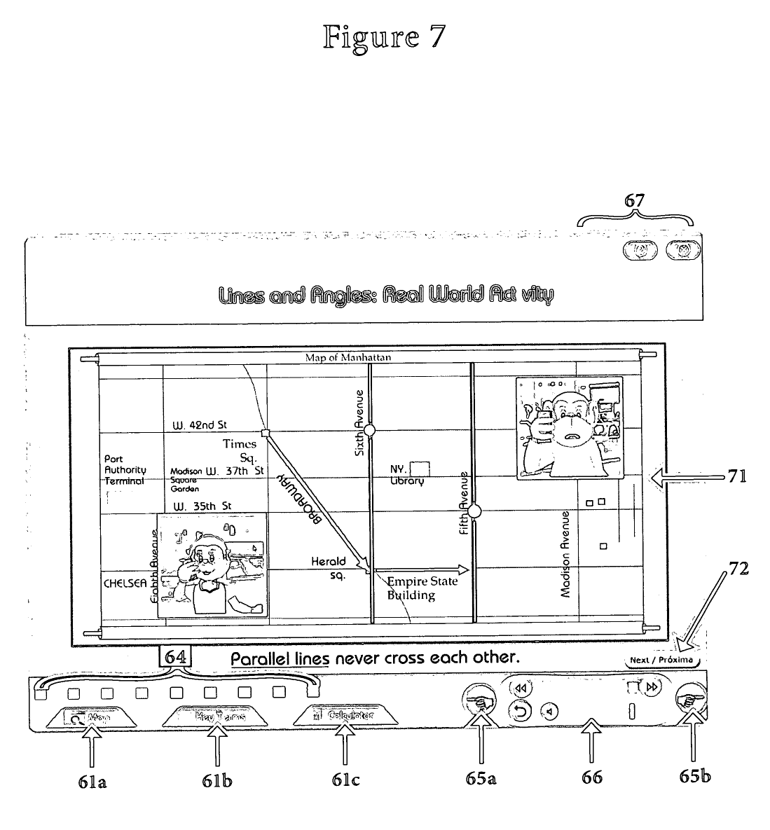

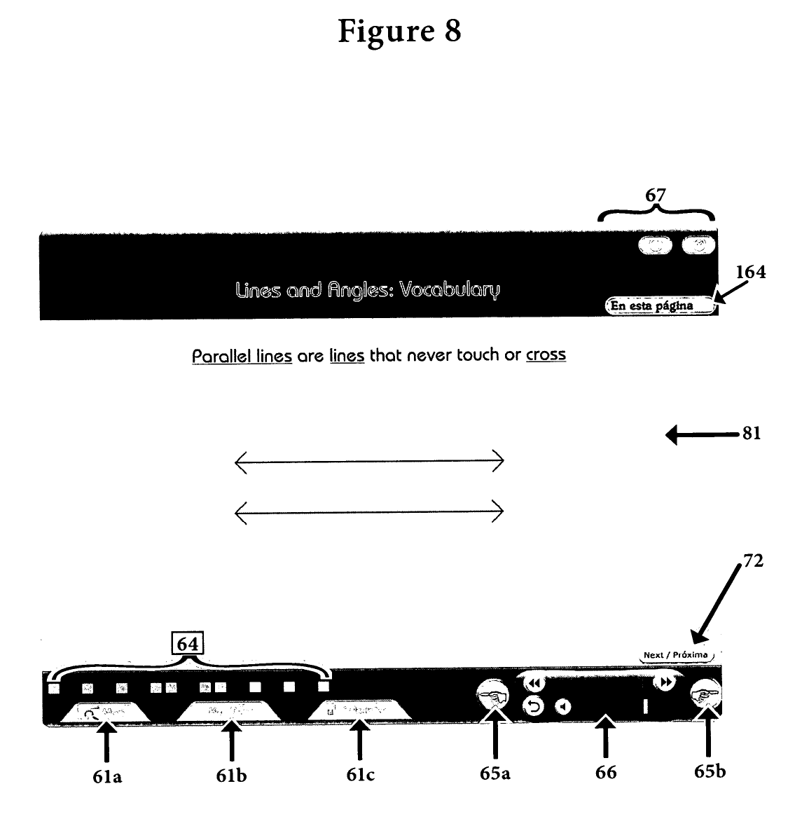

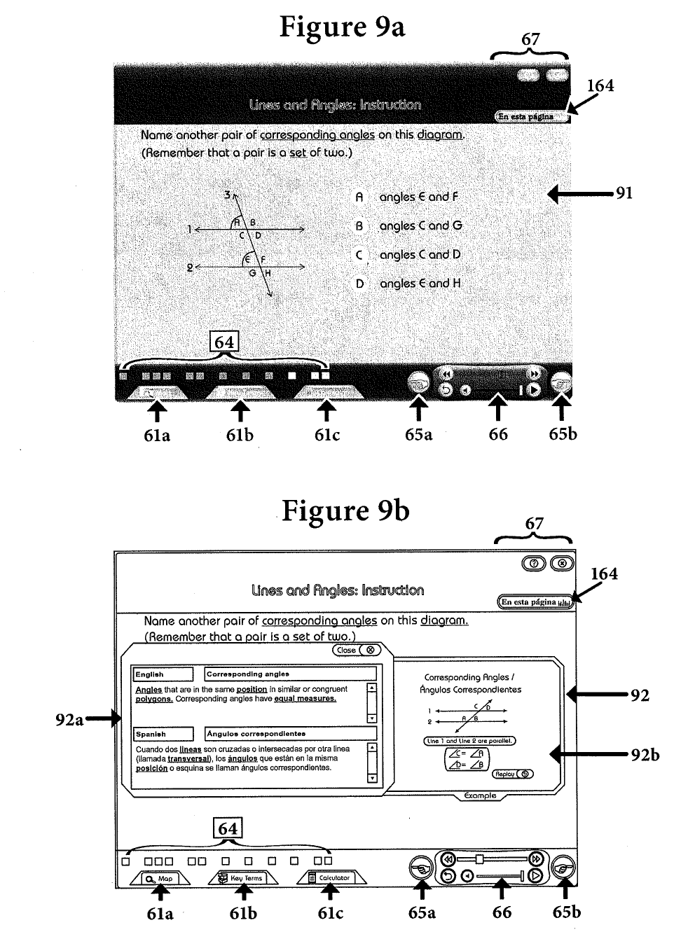

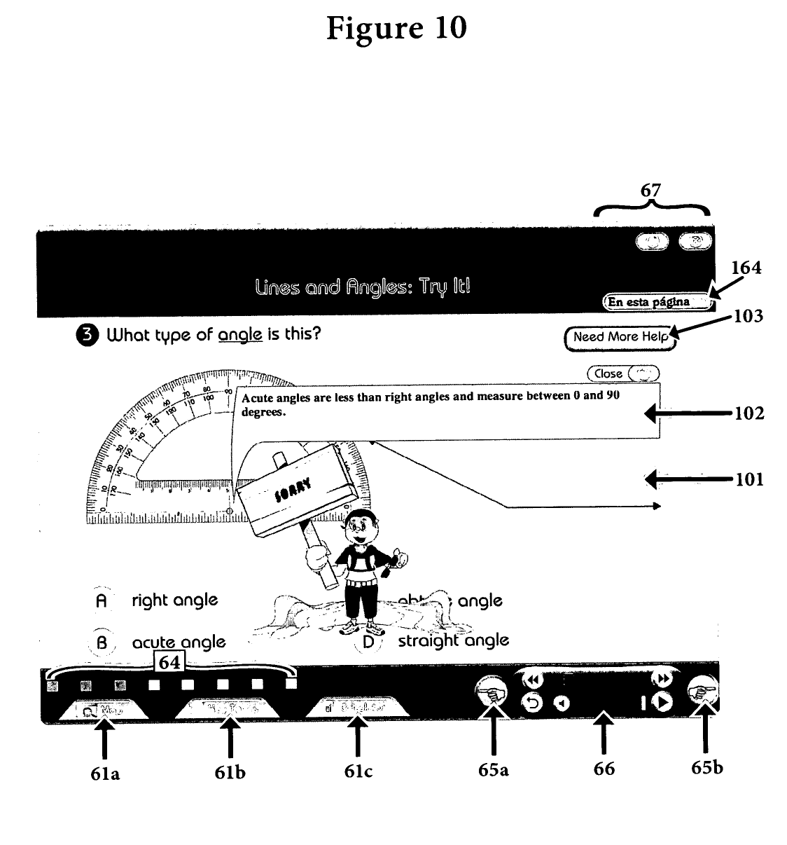

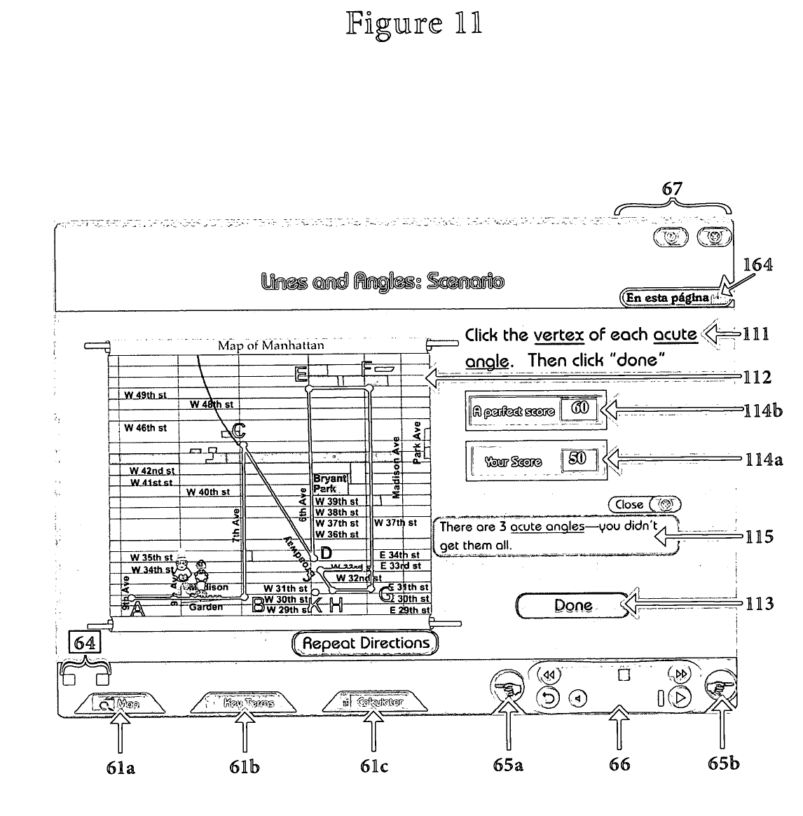

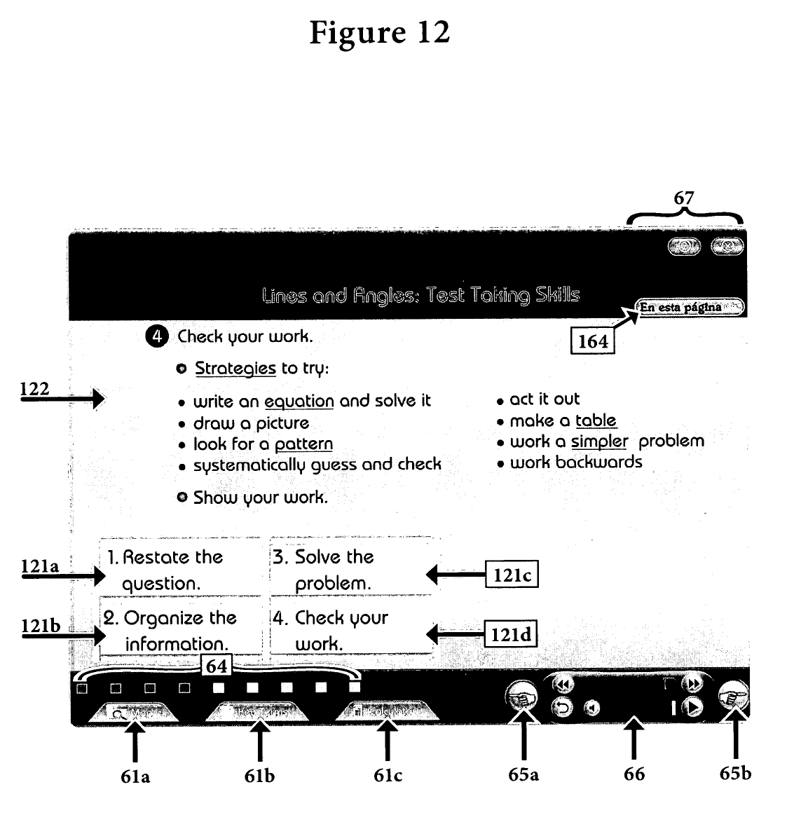

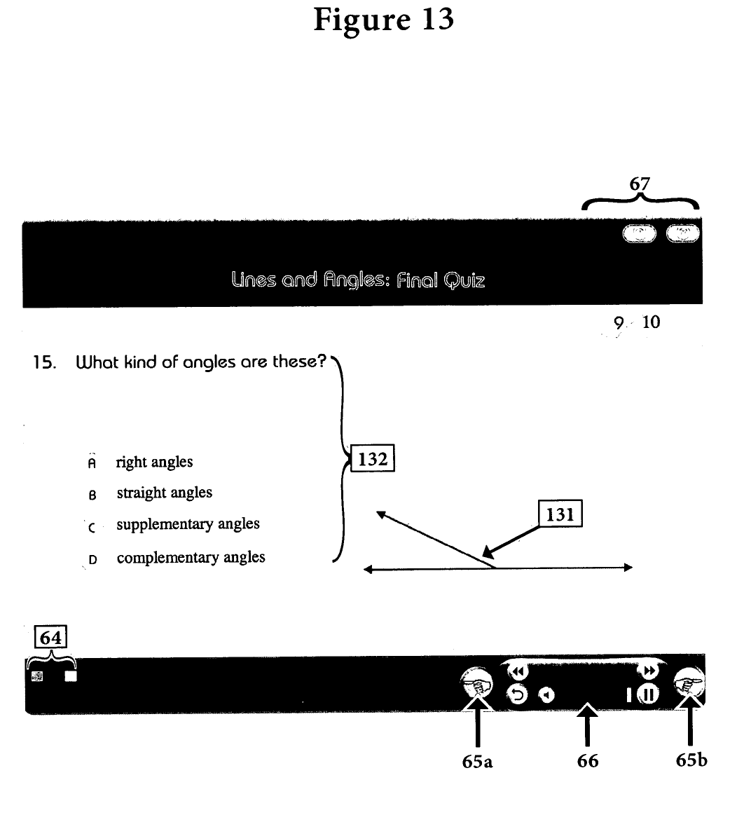

FIG. 6 shows an exemplary user interface in a non-native language for the student according to an exemplary embodiment of the present invention. A map may be selected by pressing a button 61a, key terms may be selected by pressing a button 61b, and a calculator may be selected by pressing a button 61c. In FIG. 6, a map button was selected such that the exemplary map 62 is depicted. Particularly, topics in an exemplary map 62 include: real world activity 62a, which is an example of a real-world application of the concept being studying and is described in greater detail with reference to FIG. 7 and a vocabulary item 62b. As depicted in FIG. 6, by clicking the vocabulary item 62b, the user is presented with various key terms 63. The vocabulary section 62b will be explained in greater detail with reference to FIG. 8. Furthermore, the map 62 includes an instruction 62c, which explain how to implement the concept and is explained in greater detail with reference to FIGS. 9A and 9B; a try it section 62d, which provides sample problems and is explained in greater detail with reference to FIG. 10; a game or scenario section 62e, which provides additional sample problems and is explained in greater detail with reference to FIG. 11; test taking skills section 62f, which provides test questions and is explained in greater detail with reference to FIG. 12; and a final quiz section 62g, which provides a final test and is explained in greater detail with reference to FIG. 13.

As also depicted in FIG. 6, there are small icons in a form of small squares 64 such that one icon is provided for each page. Accordingly, when a particular square is clicked, the lesson module is instructed to run the selected page i.e., that page is related to the current page. In addition, page navigation buttons 65a and 65b allow for switching to the previous or next page. Lesson navigation buttons 66 allow for control of audio and visual information in the lesson such as fast forward, rewind, pause and so on. General buttons 67 provide for a help item that explains how to navigate the system, an exit button and a back to main screen button. In a main display area in FIG. 6 an exemplary definition of “transversal” is provided. In that definition, terms for which definitions are also provided are underlined. Graphic user interface depicted in FIG. 6 is provided by way of an example only and is not intended to limit the scope of the claims in any way.

As shown by the Map 62 of FIG. 6, in an exemplary embodiment, each lesson is structured in analogous way with seven sections (62a-62g) organized around explicit subject-concept and non-social, contextual (e.g. academic) language objectives for each of the subject-concepts. The seven sheltered instructional methods (62a-62g) are present within the seven sections and are embedded at two levels: single subject-concept (e.g., corresponding angles) and multiple-related-concepts (e.g. corresponding angles, parallel lines, supplementary angles, etc.). In an exemplary embodiment, a student may choose to work through all of the related and reinforcing concepts within a particular subject lesson (e.g. Geometry Lines & Angles) or instead choose to navigate a particular path and focus on only one single concept (e.g. corresponding angles). For example, if a student is learning the single mathematical concept of “corresponding angles”, they will be presented with the academic language and concept in multiple contexts (e.g., Real World, Classroom Instruction, Assessments, Games, etc.), as well as repeating and revisiting the key vocabulary as required (Sheltered Instruction Method 5). To illustrate this point, each of the exemplary seven sections is described in greater detail below, highlighting the instructional context in which the subject-content is presented, and the possible multimedia techniques used to present the interactive content.

FIG. 7 shows a static example of the “Real World Activity” section. In this section, the student may learn about corresponding angles in a real world setting e.g., how to navigate their way through the streets of New York City using multimedia. Multimedia techniques may include the use of cartoons that employ video and synchronized audio. This may be in narrative form and include interactivities. The aim is to increase connections to student's prior knowledge, as well as to describe real-world examples and applications of the subject-concept. In this example, sheltered instruction methods 3, 5, and 6 are implemented. The concept of parallel line is explained via visual and contextual hints 71, which may clarify the concept by explaining requisite background knowledge (such as what is a line) and recycling prior knowledge (various streets and how they meet with one another). The academic language and subject-concepts is provided in multiple contexts and repeated as necessary and the key vocabulary may be revised as required. Review and evaluations are made throughout the lesson i.e., as the language and concept are being developed, not just at the end of the lesson.

As is visible in FIG. 7, various terms may also be provided in the student's native language as for example, element 72 is provided in English (non-native language) and in Spanish (student's native language), as explained in greater detail further below.

FIG. 8 shows a static example of the “Vocabulary” section 81. In this section, the student may learn words such as “corresponding” and “transversal”, as well as vocabulary that the student may need to understand underlying or closely related concepts such as “parallel” or “angles”. Additionally, students may be exposed to words such as “cross”, which have a different and specific meaning in an academic context. Interactive constructive feedback loops and other multimedia techniques (e.g. video, text, manipulatives, etc.) may be employed, along with an audio narrative that is synchronized with what is displayed on the screen.

An example of the written script is provided below in order to show the synchronicity between visual, text, and audio in the vocabulary section. The exemplary script is as follows:

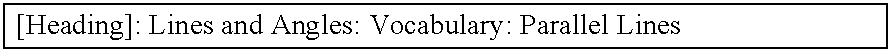

[Remove all text and images]
[voice audio] [in coach's voice] (1) Parallel lines are lines that never touch
or cross. (2)
[animate]
1. Show text in center of screen Show text, word-by-word in synch with
audio: “Parallel lines are lines that never touch or cross.”
2. show image of parallel lines, displayed horizontally as follows:

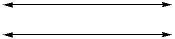

[Show Repeat and Next]

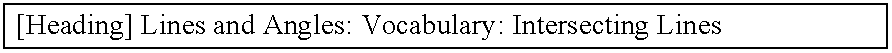

[remove all text, continue to show parallel line image]
[voice audio] [in coach's voice] (1) Intersecting lines are lines that touch
or cross at a point. (2) These are intersecting lines—(3) so are these.
[animate]
1. show text, word-by-word in synch with audio: “Intersecting lines are
lines that touch or cross at a point.”
2. animate image of parallel lines, moving them into an intersecting
position such as:

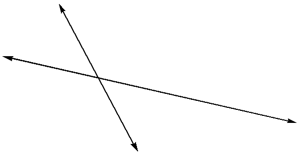

3. animate image of intersecting lines, moving into a different position.
[Show Repeat and Next]

Accordingly, the vocabulary section explains and exemplifies non-social contextual (e.g. academic) language—including both technical subject-content language and contextual language of the environment. The non-native-language student may see, hear and interact with the non-native vocabulary as it is used in context; preparing the student to understand and apply the subject vocabulary and build subject fluency. Vocabulary is explained using the non-native language. Native language may also be used to scaffold the explanation.

Accordingly, an exemplary vocabulary section such as the one depicted in FIG. 8 shows an exemplary implementation of sheltered instruction methods 2, 3, and 5. That is, the vocabulary section emphasizes subject-content and academic vocabulary and provides visual and contextual hints which may clarify the concept by explaining requisite background knowledge and recycling prior knowledge. Furthermore, the vocabulary section presents academic language and subject-concepts in multiple contexts, as well as repeats and revisits key vocabulary as required.

FIG. 9A and show static examples of the “Instruction” section. In this section, the vocabulary and concept is presented in the context of formal instruction, similar to classroom or textbook instruction. For example, the student may learn how to calculate the degree measurement of an angle. The student can control their learning experience e.g., if the student did not understand either the term or the concept of transversal, but needed to understand this idea in order to continue successfully learning about corresponding angles, he or she may repeat the last learning chunk of information (Sheltered Instruction Method 1), or perhaps get more help on the background concepts by selecting the “Need More Help” button (Sheltered Instruction Method 3), and so forth. Synchronized multimedia techniques, as well as modeling and interactive demonstrations, may be employed to break down the subject concept into small comprehensible learning chunks in order to further develop the instructional subject concept. For example, as shown in the script below.

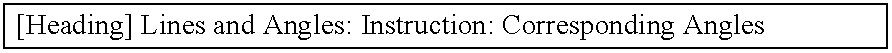

[Remove all text and images and show similar image to previous page,
except lines are labeled 1-3 and angles A-H, with transversal sloped
negatively, as:]

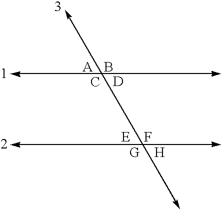

[voice audio] [in coach's voice] Here's another diagram of lines and
angles, except this time, the lines are named using numbers (1) and the
angles with letters. (2) Lines (3) 1 and (4) 2 are parallel lines. They are
intersected by (5) line 3. These angles (6) are related to each other in
special ways as we have seen before. For example, angles that are in the
same positions or corners, like angles (7) A and (8) E, are (9)
corresponding angles. Can you name another pair of corresponding angles
on this diagram? (10)
[animate]
1. flash each number labeling lines (1-3) in sequence, quickly
2. flash each letter labeling angles (A-H) in sequence, quickly
3. highlight line 1 (the line, not the number)
4. highlight line 2
5. highlight line 3, pause a few seconds, and then remove highlights from
lines 1 and 2
6. flash each angle, in sequence, quickly
7. flash angle A (flash angle, not letter)
8. flash angle E
9. show label between lines 1 and 2 and to the left of line 3:
“corresponding angles” with arrows pointing to angles A and E, then
remove after a few seconds
10. show text:
Name another pair of corresponding angles on this diagram.
(Remember that a pair is a set of two.)

[show graphic letter A] angles E and F
[show graphic letter B] angles C and G
[show graphic letter C] angles C and D
[show graphic letter D] angles E and H

11. multiple choice interaction: correct choice is B. angles C and G;
incorrect feedback if student selects A, show monkey and mole holding
a sign that says “Angles E and F are supplementary angles. Try again!”
incorrect feedback if student selects C show monkey and mole holding a
sign that says “Angles C and D are supplementary angles. Try again!”
incorrect feedback if student selects D, show monkey and mole holding a
sign that says “Angles E and H are opposite angles. Try again!” If student
selects correct answer B, show monkey and mole cheering, holding a sign
(or saying) that says “Yes!”, pause a few second, remove question and
answer choices, and continue to execute script.
[voice audio] [in coach's voice] Right again. When the traversal line 3
intersects the two parallel lines 1 and 2, corresponding angles are formed.
Angles (1) C and (2) G are (3) corresponding angles because they are in
the same position or corner.
[animate]
1. flash angle G
2. flash angle F
3. in question text flash text: “corresponding”
[Show Repeat and Next]

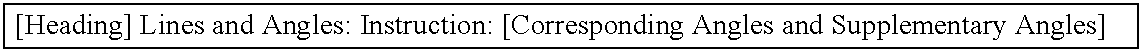

[Remove all text and images except continue to show parallel lines intersected by a transversal
with lines and angles labeled]

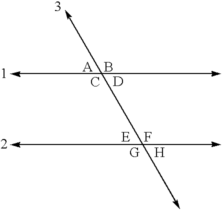

[voice audio] [in coach's voice] Using what you know about supplementary angles, opposite
angles, and corresponding angles; if you know the degree measure of any one angle in a diagram
like this one, you can figure out the degree measure of any other angle. For example, let's say
that angle A is (1) 60 degrees. Angles (2) B and (3) C are supplementary to angle A so these
angles measure (4) 120 degrees, and angle (5) D is opposite to angle (6) A, so angle D measures
(7) 60 degrees. Finally, you know that every pair of corresponding angles have the same degree
measurement so angle (8) A has the same degree measurement as its corresponding angle (9) E,
angle (10) B has the same degree measurement as its corresponding angle (11) F, angle (12) C
has the same degree measurement as its corresponding angle (13) G, and angle (14) D has the
same degree measurement as its corresponding angle (15) H. Study these relationships for a
minute and then click Next to try another problem.
[animate]
1. add label to angle A: “60°”
2. flash angle B
3. flash angle C
4. add labels in turn to angles B and C: “120°”
5. flash angle D
6. flash angle A
7. add label to angle D: “60°
8. flash angle A
9. add label to angle E: “60°
10. flash angle B
11. add label to angle F: “120°
12. flash angle C
13. add label to angle G: “120°
14. flash angle D
15. add label to angle H: “60°

FIG. 9A shows an example of asking the student to select a pair of corresponding angles 91. FIG. 9B shows using the native language 92 to support the instruction 91. FIG. 9B shows an example of building on necessary background knowledge and academic vocabulary 92a and walking a student through an example in 92b. The written script walking the student through instruction of a concept is provided above.

As depicted in FIGS. 9A and 9B, the subject concepts are broken into small comprehensible learning chunks. Activities and interactive demonstrations in multiple contexts are provided to help comprehend the broken down subject concept. Also, as is visible in FIG. 9B, the academic language and key vocabulary are reviewed. Accordingly, the instruction section implements sheltered instruction methods 1, 4, and 5.

FIG. 10 shows a static example of practice questions e.g., the “Try It”, section. In this section, the student may be exposed to the concept by being asked to perform a specific task such as compare a complementary and supplementary angle and determine the type of angle 101. Synchronized multimedia techniques including several interactive tasks that the student must perform that reinforce the vocabulary and instructional learning of a concept, such as solving a mathematical equation. Visual and contextual clues may be provided and instructional hints which reference and recycle prior vocabulary and concept learning. FIG. 10 shows an example of how hints 102 support the instruction. Clues such as hints 102 may be provided by requesting more help 103. In this case, the hints 102 is an example of recycling previous knowledge.

In FIG. 10, visual and contextual hints clarify the concept by explaining requisite background knowledge and recycling prior knowledge. Also, the academic language and subject-concepts are provided in multiple contexts, and the key vocabulary is repeated. In an exemplary practice questions section, the development of language and concept are being assessed such that additional questions or hints may be provided based on student's understanding of the concept. Also, trouble areas may be identified so that additional questions are provided in the troubled areas. For example, practice questions may be provided for a particular concept (optionally, intermixed with other concepts) until the student correctly answers a predetermined number (such as three or five) of questions without using hints. The practice questions section utilizes exemplary sheltered instruction methods 3, 5, and 7.

FIG. 11 shows a static example of the “Game or Scenario” section, the student may play a game in which they can only move forward or score points by maneuvering corresponding angles. Synchronized multimedia techniques in an interactive game or real world scenario that the student plays, which also reinforces the learning of the technical, contextual vocabulary, and facilitates concept fluency. FIG. 11 also shows an example of how hints 102 support the instruction. In this case, the hint is an example of explicitly teaching a student how to read for meaning (and action) in a non-native language, as there are often cultural norms for presenting instructions, asking questions, etc. For example, in FIG. 11, the student is asked to find vertex of each acute angle 111 in obtaining directions to a certain place. The student may obtain definitions of the underlined key vocabulary terms in the question 111. The various angles are depicted in map 112, which may be a similar scenario to the one provided in the instructions sections or may be a different scenario. The student clicks on the acute angles and indicates when he is done 113. The student is then provided with points obtained 114a out of maximum possible points 114b and an explanation is provided 115. The student may request retry to find the vertexes or may ask for the answer. Accordingly, FIG. 11 presents academic language and subject-concepts in multiple contexts while revisiting key vocabulary as required. Also, since in FIG. 11, the questions are provided in the context of real world scenario, the student can connect the game scenario to the real world activity. The game or scenario section utilizes exemplary sheltered instruction methods 5 and 6.

FIG. 12 shows a static example of the “Test Taking Skills” section. In this section, the student may be asked a question about corresponding angles in the context of a formal standardized test question and then be asked to solve a problem. This time the content is being represented (e.g., repeating and revisiting technical and contextual language and the concept) in the context of a problem solving process. For example, the language of an assessment can be quite unique and culturally-laden. Take the question, If X not Y is a corresponding angle, which of the following statements is true about angle Z? Such a question can be very tricky for a non-native language student. In the virtual learning system, the student would learn strategies for problem-solving (exemplary sheltered instruction method 5) and explicitly learn some of the constructions used in examinations such as “which of the following statements is true” and “if not X”, as well as context-specific vocabulary such as “statements” (exemplary sheltered instruction method 2), and so forth. Synchronized multimedia techniques and interactive test questions are delivered in a way that helps prepare the non-native student to take a quiz or test on the material covered in the lesson or subject-concept.

For example, as depicted in FIG. 12, for each question, the user may request to restate questions 121a, may request help or an example of how to organize information in the question 121b, may request help with solving the problem 121c or may request help or strategies for checking the solving of the problem 121d. For example, strategies 122 for checking the work may be provided as depicted in FIG. 12.

In improving student's test taking skills, the subject concepts are again broken into small comprehensible learning chunks as necessary. The solving techniques may be interactively demonstrated and the academic language and subject-concepts are presented multiple contexts (various techniques for solving the problem) while revisiting key vocabulary. Also, review and assessment of the language and concept are being developed, not just at the end of the lesson. The test taking skills section utilizes exemplary sheltered instruction methods 1, 4, 5, and 7.

FIG. 13 shows a static example of the testing (“Final Quiz”) section. In this section, the student takes a graded quiz that covers the material presented in the lesson or topic. For example, the student may be shown a diagram 131 and asked to identify a type of angle 132. In this section, the question may be asked without the scaffold and the extra support features that are available throughout the previous six sections. The learner or the teacher may be given the option as to whether to turn on or off individual features such as native language support 61a, glossary 61b, calculator 61c, and navigational tools 65a, 65b, and 66. After taking the final test, the student may again review any of the sections. Upon obtaining a certain score in the testing section, the lesson may be completed and the student congratulated on successfully mastering the concept and academic vocabulary. The test taking skills section utilizes exemplary sheltered instruction method 7, reviewing and assessing student's understanding throughout the lesson not just at the end.

Since in an exemplary embodiment, the multimedia subject-content is delivered via a web server, the student can decide the order in which he or she learns the content. For example, the student may choose to navigate in a linear fashion and learn the subject content in the sequence shown in FIG. 6 (e.g., Real World section, Vocabulary section, Instruction section, practice questions section, Game or Scenario section, Test Taking Skills section, and the testing section, respectively). Alternatively, the student can navigate and explore the content in a non-linear fashion and engage in the learning process, (i.e., interacting in multiple ways with the content). For example, it may be possible for a student to start a lesson by playing the game; however, discovering that he or she does not have the skills to play the game, he or she visits the vocabulary or instructional sections to retrieve the necessary information. Such students are both learning the subject and taking control of their own learning experience. The virtual learning system in an exemplary embodiment provides uniformity in utilizing various exemplary sheltered instruction methods and flexibility of each individual student.

Throughout the lesson according to an exemplary, non-limiting embodiment of the present invention. The instructions, questions, answers, explanations, etc are in non-native language yet native language support is available in various sections of the lesson. In an exemplary embodiment, the virtual learning system and apparatus uses the non-native language as the primary language of instruction, and supports that instruction with native language instruction and translations. Also, student interaction with the virtual learning system is in the non-native language but is supported with the native language.

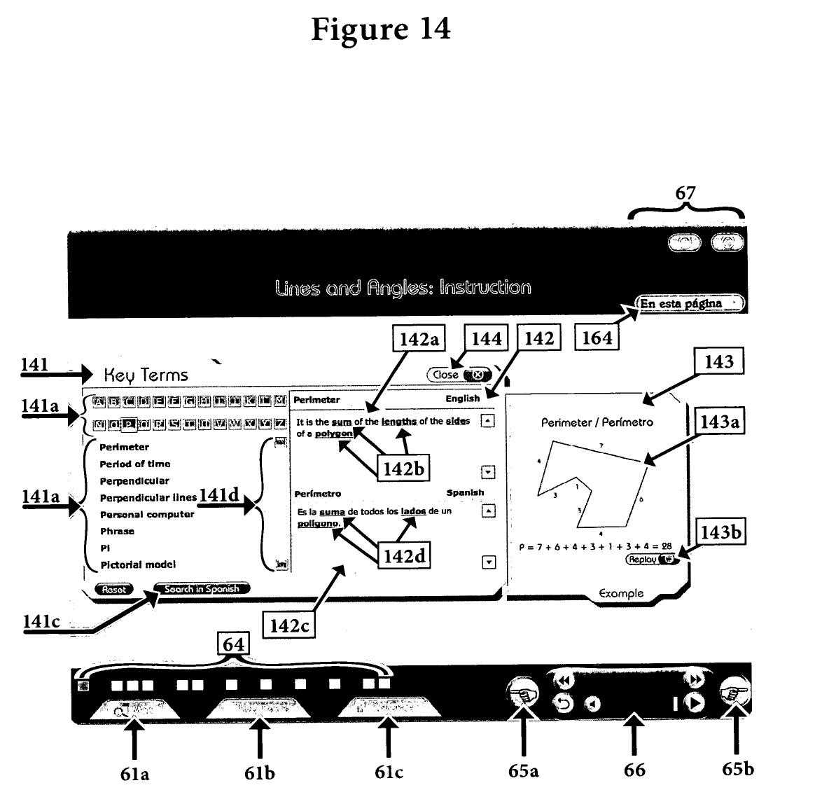

FIG. 14 shows a graphical depiction of the Native Language Support features from a non-native-language student's view (e.g., user interface). As depicted in FIG. 14 when the user clicks the key term 61b, the Key Terms tab 141 is provided. In the Key Terms tab 141, a user may select a particular letter 141a and all key vocabulary terms for this letter are provided in a list 141b, which can be viewed using scroll bar 141d. The student may also search for a definition of a particular term in the native language 141c. When the student selects a particular key term e.g., “perimeter,” the definition of the key term is provided in key terms hyperlink area 142. In particular, a definition in non-native language 142a is provided with various hyperlinked terms 142b. By clicking on the hyperlinked term 142b, the user is provided with a definition of the term. Also, the definition in the native language 142c is provided also with hyperlinked terms 142d. Also, a visual and audio example 143 of the selected definition may be provided. The visual example 143a is shown in both native and non-native language and is accompanied by audio explanation in a native language 143b.

The student may view a definition of a particular term at any time during the lesson (optionally, this native language support may be turned off for various sections e.g., the testing section). As the virtual lesson is played to the student e.g., in a form of a slide show or a video, the student may click on key terms button 61b at any time during the lesson or on a particular underlined term depicted during the lesson, the lesson will then be paused and the student will be provided with the definition 141. When the student completed studying the definition, the student clicks close 144, and the lesson is resumed from the paused point. In other words, in an exemplary, non-limiting embodiment of the present invention, the concept is provided in non-native language with support in the native language.

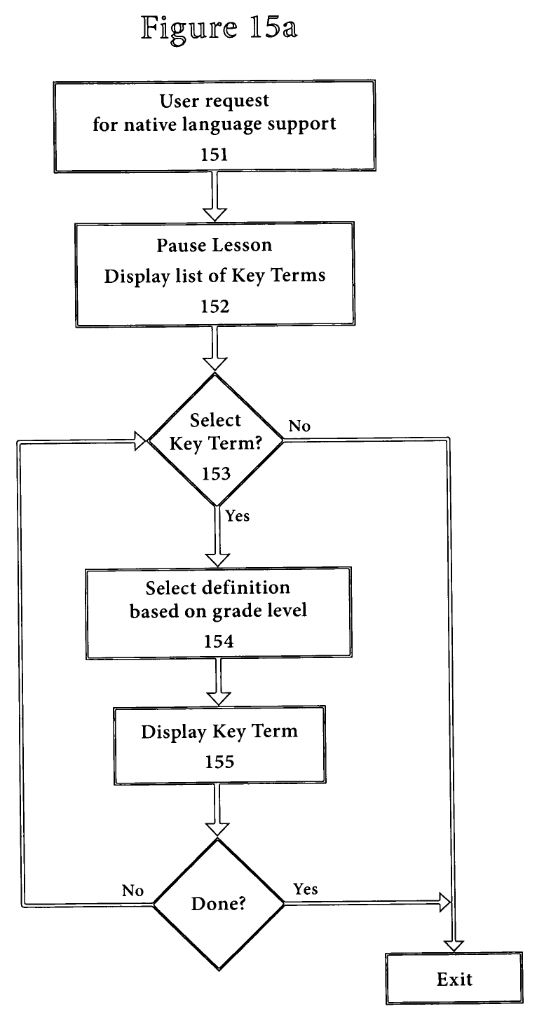

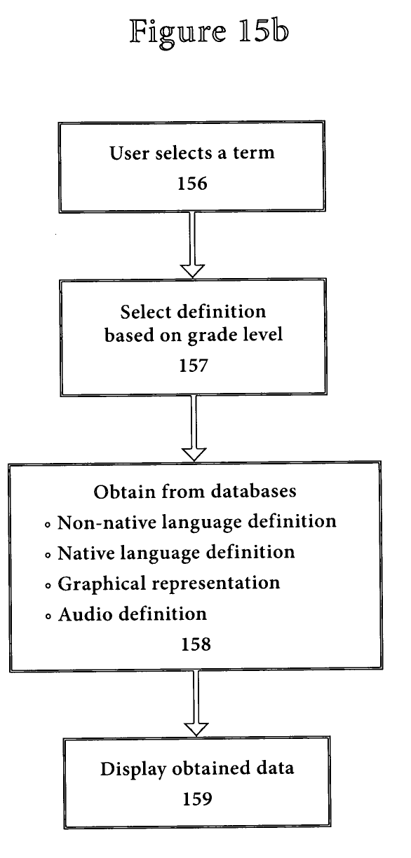

FIGS. 15A and 15B are flow charts illustrating various methods of providing native language support in a virtual lesson to a student using multimedia according to an exemplary embodiment of the present invention. When a student is taking a lesson, the lesson module and the page module may both be running and displaying elements on the student's computer display. The lesson module provides support features, such as a calculator, a glossary of key terms, and a native language support. In an exemplary embodiment of the present invention the native language support is provided in key term definition (FIG. 14, element 142) and native language audio support for this page (FIG. 14, element 143).

In FIG. 15A, the student clicks the Key Terms button in operation 151. The lesson module pauses the lesson and displays an alphabetical list of all the key terms it has in its database for the specific grade or level of the student in operation 152. The student can choose which key term to display in operation 153. The list is displayed until the student chooses the term or exits the native language support feature. When the student selects a term in operation 153, the lesson module chooses which database to use to retrieve the definition of the key term, based on the student's designation in operation 154 and displays the key terms with examples in native and non-native languages in operation 155. When the student is done, the student exits the native language support and the lesson continues from the previously ended portion.

In FIG. 15B, the student selects or clicks a linked key term that is displayed by the page module during the lesson in operation 156. The lesson module then chooses which database to use to retrieve the definition of the key term, based on the student's designation (e.g., grade or level) in operation 157. The lesson module retrieves the appropriate non-native language (e.g., English) definition, the appropriate native language definition (e.g., Spanish), the appropriate graphical representation of the definition, and the appropriate audio definition for the key term in operation 158. Finally, the lesson module displays the appropriate definition elements just retrieved for the key term in operation 159.

In FIGS. 15A and 15B, various process flows of the Native Language feature are described. Most lesson pages may provide an audio description of the concepts that are presented on the page. The student can hear this audio description by clicking on a Native Language button that is provided by the lesson module. The lesson is then temporarily suspended while the native language audio is played.

The native language audio according to an exemplary embodiment of the present invention is to provide an additional tool to help the student become fluent in the content that is being taught, tested and/or applied in a non-native language environment. Whilst content fluency in the native tongue would be an additional benefit to the multi-language learner, the explicit dual intertwined objective of an exemplary virtual learning system is to integrate the learning of the subject with the learning of the non-native, non-social contextual language. As such, embedded sheltered instruction methods help the student become proficient in the subject matter using the non-native language—not the student's native language. Therefore, in contrast to the non-native-language text, graphics and audio multimedia which are typically always synchronized; the native-language text, graphics and audio multimedia may or may not be synchronized i.e., sheltered instruction in the student's native language may not typically be provided. The use of native language audio within the virtual learning system may be compared to the help that a teacher or bilingual aid might provide to a student, by whispering native language explanations of the concept being described on the screen, in the student's ear in a subject classroom in which the primary instruction is the non-native language. In an exemplary embodiment of the present invention, the native language may be the primary language of instruction and the non-native language may be the support language.

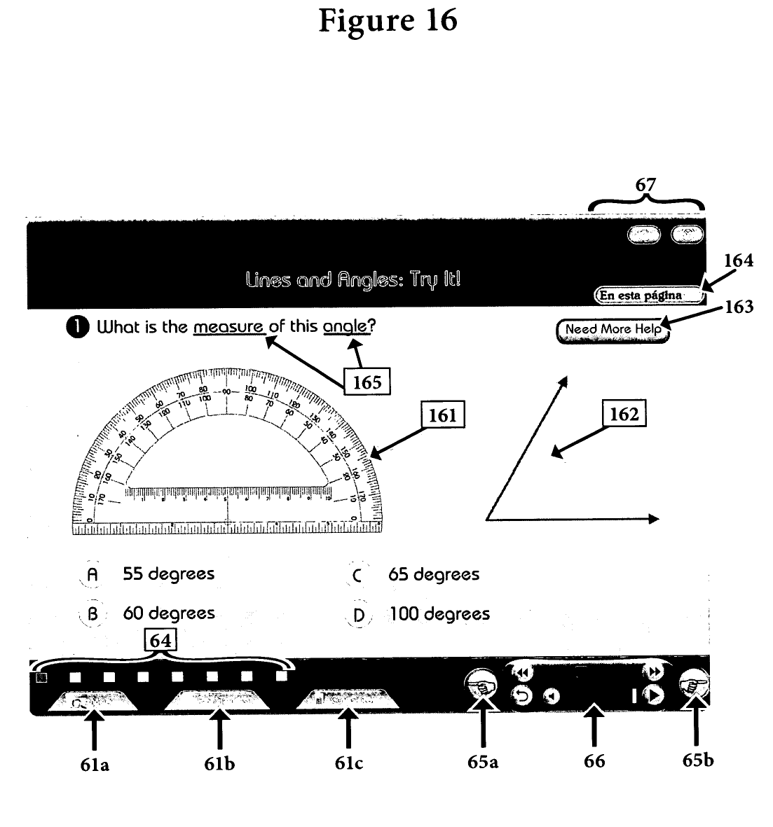

In an exemplary, non-limiting embodiment of the present invention, a virtual learning system provides additional interactive support tools as explained in greater detail with reference to FIG. 16. With reference to FIG. 16, exemplary interactions of the student with the virtual learning system are provided.

In the portion of the concept development (e.g., corresponding angles) captured in FIG. 16, a student manipulates an interactive tool (e.g., protractor) 161 by clicking and dragging it onto the angle shown 162. If the student needs more help, he or she can click on the “Need More Help” button 163 in the upper right corner, and in a self-contained box, receive hints which may reveal concept background and recycle prior knowledge. Directly above the “Need More Help” button is a link to the “Native Language Audio” button (e.g., Spanish) 164; clicking this button brings up a native language translation of the instructional content on the Page and, if the student needs vocabulary support within the context of what is being taught or practiced on any page, he or she can click on the hyperlinked (underlined) words 165, which brings up a self-contained screen and retrieves a technical and/or contextual definition in both the native and non-native language which may have a graphic representation and audio file.

Alternatively as explained above, the student can click on the “Key Terms” tab 61b at the bottom center of the screen to retrieve any technical and/or contextual definition regardless of whether is shown on the current page. To the right of the “Key Terms” tab 61b is the “Calculator” tab 61c, which may display a built-in, multi-function calculator. Next to the “Calculator” is a “Navigation Bar” 66, which may operate like a “movie bar” on a DVD. The student may go to the previous instructional page 65a, go to the next instructional page 65b, fast rewind within the page 66, fast forward within the page 66, replay the last learning chunk 66, pause/resume 66, toggle the sound on/off 66, and adjust the sound volume 66. Just beneath the instructional content, there may be a “Progress Indicator”, which shows where the student is within the lesson. The student may use the progress bar to go directly to other pages within the lesson. On the bottom left, there is a “Map” tab 61a, which may display a pop-up list in the non-native and native languages of all the key concepts and all the sections (i.e., sheltered strategies used to develop the concepts). Clicking on any of the displayed elements will bring the user directly to that content. The “Map” is further described in FIG. 6. In the upper right is a “Query” button 67, clicking this button which will enable the student to ask an expert a content-related question which references the precise learning chunk, concept and page which the student needs help with. This may be done via a medium such as email, text chat, webcam, VOIP, etc. This expert may be a “live” teacher, tutor or mentor, or may be a “virtual” teacher, tutor or mentor. Next to the “Query” button is a “Log Out” button 67, which may return the student to the full set of lessons and an online tutorial. Next to this is a “Back” button 67, which takes the student back to the previous page.

Accordingly, a method, a system, and an apparatus consistent with an exemplary embodiment of the present invention relates to a virtual learning system that educates non-native-language students in various academic topics unrelated to languages (subject). More particularly, an exemplary embodiment of the present invention is consistent with providing a virtual learning system for learning and teaching a subject in a non-native language by embedding sheltered instruction principles and methods into interactive multimedia content. Hence, integrating the learning of the subject with the learning of the non-native language including the requisite technical language of the subject and the contextual, specialized language of the non-social environment.

For example, in one embodiment, the virtual learning system is implemented as an internet-based, interactive educational program to help Spanish speaking students (English language learners) who are living in the United States learn mathematics in English including the technical language of mathematics (e.g., coefficient, hypotenuse, tessellation) and the contextual, specialized language (e.g., academic) of the classroom and the academic assessment (e.g., exemplify, synthesize, which of the following). The system and method according to an exemplary embodiment provides delivery of multimedia sheltered instruction (i.e., scaffolded academic subject content) using the non-native language as the primary language of instruction, supported with native language instruction and translations, and other interactive tools.

It will be understood that the use of the virtual learning system is provided as an exemplary embodiment. The previous description of various embodiments and features of the present invention are provided to enable a person skilled in the art to make and use the present invention. Moreover, various modifications to these embodiments will be readily apparent to those skilled in the art, and the generic principles and specific examples defined herein may be applied to other embodiments without the use of inventive faculty. For example, some or all of the features of the different embodiments discussed above may be combined into a single embodiment. Conversely, some of the features of a single embodiment discussed above may be deleted from the embodiment. Therefore, the present invention is not intended to be limited to the embodiments described herein but is to be accorded the widest scope as defined by the features of the claims and equivalents thereof.

What is claimed is:

1. An internet-based virtual learning system comprising:
an input device, which receives user input;
a datastore, which stores academic content, where at least a portion of the academic content is stored in native and non-native languages;
a processor, which obtains the academic content based on the user input, and
an output device, which outputs the academic content provided by the processor to a user,
wherein the academic content is obtained by the processor with sheltered instruction in the non-native language, and
wherein upon a user request, the providing of the academic content is paused and at least one key term of the academic content is provided in the native language.

2. The internet-based virtual learning system according to claim 1, wherein the processor searches the datastore to obtain a level of the user and obtains differing academic content based on the found level of the user.

3. The internet-based virtual learning system according to claim 1, wherein the processor is a web server and wherein the output device is a remote web browser, and wherein the web server and web browser communicate via internet.

4. The internet-based virtual learning system according to claim 1, wherein the output device displays the academic content in a form of a video in the non-native language and wherein, based on the user input, the video content lesson is paused and support in the native language is provided.

5. The internet-based virtual learning system according to claim 1, wherein:
the output device comprises a visual display and an audio system, and
the academic content comprises:
a real world activity data, which is continuously illustrated by the output device in the non-native language visually and audibly and which is an implementation of the academic concept in a real world activity,
a vocabulary data, which is illustrated in the non-native and native languages visually and audibly by the output device and which is the at least one key term related to the academic content provided upon a request from the user,
instruction data, which continuously explains the academic concept in the non-native language visually and audibly by the output device,
practice questions data, which is illustrated in the non-native language visually and audibly by the output device and which is data that shows how to solve a particular problem of the academic concept,
game data, which is illustrated in the non-native language visually and audibly by the output device and which is data providing implementation of the respective academic concept in a game setting,
test taking skills data, which is illustrated in the non-native language visually and audibly by the output device and which is data showing how to improve test taking skills related to the respective academic concept, and
test data, which tests understanding of the respective academic concept and is provided to the user by the output device.

6. The internet-based virtual learning system according to claim 5, wherein the real world activity data, the vocabulary data, the instruction data, the practice questions data, the game data, the test taking skills data, and the test data form a lesson with respect to the academic content, and wherein the real world activity data, the vocabulary data, the instruction data, the practice questions data, the game data, the test taking skills data, and the test data are provided in a predetermined order.

7. The internet-based virtual learning system according to claim 5, wherein the real world activity data, the vocabulary data, the instruction data, the practice questions data, the game data, the test taking skills data, and the test data form a lesson with respect to the academic content, and wherein the real world activity data, the vocabulary data, the instruction data, the practice questions data, the game data, the test taking skills data, and the test data are provided in an order determined by user input.

8. The internet-based virtual learning system according to claim 5, wherein the real world activity data, the vocabulary data, the instruction data, the practice questions data, the game data, the test taking skills data, and the test data form a lesson with respect to the academic concept, and wherein, based on the user request, the lesson is paused and the vocabulary data is provided in the native and non-native languages.

9. The internet-based virtual learning system according to claim 5, wherein the real world activity data, the vocabulary data, the instruction data, the practice questions data, the game data, the test taking skills data, and the test data form a lesson and wherein, upon the user request, the lesson is paused and current page is provided visually and audibly by the output device in the native language.

10. The internet-based virtual learning system according to claim 1, wherein the sheltered instruction obtained by the processor comprises:
breaking down academic content into small comprehensible portions;
emphasizing the academic content and the at least one key term related to the academic content;
providing visual and contextual hints which clarify the academic content by explaining requisite background knowledge and recycling prior knowledge;
modeling activities and providing interactive demonstrations and activities related to the academic content;
presenting the academic vocabulary and the subject in multiple contexts in both the native and non-native languages, as well as repeating and revisiting the at least one key term as required;
increasing connections between the academic content and real-life experience of the user; and
reviewing and assessing throughout a lesson user's understanding of the academic content.

11. A computer readable medium storing instructions for virtual learning of academic content in a non-native language, the instructions comprising:
instructions for receiving user input;
instructions for storing academic content, where at least a portion of the academic content is stored in native and non-native languages;
instructions for obtaining the academic content based on the received user input; and
instructions for outputting the academic content to a user,
wherein the academic content is obtained with sheltered instruction in the non-native language, and
wherein upon a user request, the providing of the academic content is paused and at least one key term of the academic content is provided in the native language.

12. The computer readable medium according to claim 11, wherein the outputting of the academic content is sequentially and continuously provided in a form of a video and audio data and wherein the outputting of the academic content is paused for the providing of the information related to the at least one key term in the native language.

13. The computer readable medium according to claim 11, wherein said obtaining instructions comprise instructions for searching the datastore to obtain a level of the user and instructions for obtaining different academic content based on the found level of the user.

14. The computer readable medium according to claim 11, further comprising:
instructions for continuously outputting in the non-native language visually and audibly a real world activity data, which is an implementation of the academic content in a real world activity,
instructions for outputting in the non-native and native languages visually and audibly a vocabulary data, which is the at least one key term related to the academic content provided upon a request from the user,
instructions for continuously outputting instruction data, which is data that explains the academic concept in the non-native language visually and audibly,
instructions for outputting in the non-native language visually and audibly practice questions data, which is data that shows how to solve a particular problem of the academic concept,
instructions for outputting in the non-native language visually and audibly game data, which is data providing implementation of the respective academic concept in a game setting,
instructions for outputting in the non-native language visually and audibly test taking skills data, which is data showing how to improve test taking skills related to the respective academic concept, and
instructions for outputting test data, which tests understanding of the respective academic concept.

15. The computer readable medium according to claim 14, wherein the real world activity data, the vocabulary data, the instruction data, the practice questions data, the game data, the test taking skills data, and the test data form a lesson with respect to the academic content, and wherein the real world activity data, the vocabulary data, the instruction data, the practice questions data, the game data, the test taking skills data, and the test data are provided in a predetermined order.

16. The computer readable medium according to claim 14, wherein the real world activity data, the vocabulary data, the instruction data, the practice questions data, the game data, the test taking skills data, and the test data form a lesson with respect to the academic content, and wherein the real world activity data, the vocabulary data, the instruction data, the practice questions data, the game data, the test taking skills data, and the test data are provided in an order determined by user input.

17. The computer readable medium according to claim 14, wherein the real world activity data, the vocabulary data, the instruction data, the practice questions data, the game data, the test taking skills data, and the test data form a lesson with respect to the academic concept, and wherein, based on the user request, the lesson is paused and the vocabulary data is provided in the native and non-native languages.

18. The computer readable medium according to claim 14, wherein the real world activity data, the vocabulary data, the instruction data, the practice questions data, the game data, the test taking skills data, and the test data form a lesson and wherein, upon the user request, the lesson is paused and current page is provided visually and audibly by the output device in the native language.

19. The computer readable medium according to claim 11, wherein the sheltered instruction stored on the computer readable medium comprise:
breaking down the academic content into small comprehensible portions;
emphasizing the academic content and the at least one key term related to the academic content;
providing visual and contextual hints which clarify the academic content by explaining requisite background knowledge and recycling prior knowledge;
modeling activities and providing interactive demonstrations and activities related to the academic content;
presenting the academic vocabulary and the subject in multiple contexts in both the native and non-native languages, as well as repeating and revisiting the at least one key term as required;
increasing connections between the academic content and real-life experience of the user; and
reviewing and assessing throughout a lesson user's understanding of the academic content.

20. A computer implemented method for virtual learning of academic content in a non-native language, the method comprising:
receiving user input;
storing academic content, where at least a portion of the academic content is stored in native and non-native languages;
obtaining said stored academic content based on the received user input; and
outputting the obtained academic content,
wherein the academic content is obtained with sheltered instruction in the non-native language, and
wherein upon a user request, the outputting of the academic content is paused and at least one key term of the academic content is provided in the native language.

21. The computer-implemented method according to claim 20, wherein the academic content is non-social content unrelated to languages.

22. A graphical user interface provided on a computer, comprising:
a first view, which provides at least one key concept of an academic content in a non-native language of a user, wherein terms displayed in the first view for which definitions in a native language are available are marked in the first view;
a tool bar, which provides menu options comprising a first option including a video stream introduction of the at least one key concept in a non native language, a second option including an interactive game demonstrating the at least one key concept in the non native language, and a third option including a test of the at least one key concept in the non native language; and
a second view, which replaces the first view and displays the definitions in the native language when a user selects a term marked in the first view, and returns to the first view upon further user input.
